(19) United States
(12) Patent Application Publication
(10) Pub. No.: US 2024/0140047 A1
(43) Pub. Date: May 2, 2024

(54) Method and device for manufacturing containers adapted to contain a food substance for the preparation of beverages

(71) Applicant: OPEM S.P.A., PARMA (IT)

(72) Inventor: Fabio BINACCHI, SORBOLO (PR) (IT)

(21) Appl. No.: 18/536,698

(22) Filed: Dec. 12, 2023

(30) Foreign Application Priority Data
Nov. 12, 2018 (IT) 102022000025479

(51) Int. Cl. B29C 65/00

(52) U.S. Cl. CPC B29C 66/545; B29C 66/8322

(57) ABSTRACT

A method is described for manufacturing packages (100) adapted to contain a food substance for the preparation of beverages, comprising the steps of: arranging an outer cup (105) of impermeable material and a die cut (110, 410) of permeable material having larger dimensions with respect to an opening (145) of the outer cup (105) and resting thereon; bringing a pusher body (295, 425) in contact with a portion of the die cut (110, 410) facing the cavity of the outer cup (105); simultaneously moving the pusher body (295, 425) and an ultrasonic welding sonotrode (275) superimposed thereon towards a bottom wall (115) of the outer cup (105), so as to axially insert the die cut (110, 410) and at least one portion (285) of the ultrasonic welding sonotrode (275) in the outer cup (105); activating the ultrasonic welding sonotrode (275) so as to weld the die cut (110, 410) to the mouth (125) of the outer cup (105); extracting the ultrasonic welding sonotrode (275) and the pusher body (295, 425) from the outer cup (105).

### TECHNICAL FIELD

The present invention relates to a method and device for manufacturing packages adapted to contain a food substance for the preparation of beverages, such as coffee.

In particular, the present invention relates to the manufacture of single-serving packages which, once filled with the food substance, are marketed for use in conjunction with corresponding extraction machines, so as to allow the automatic or semi-automatic preparation of the aforesaid beverages.

### BACKGROUND

Numerous types of single-serving packages for preparing beverages are currently known and are often referred to with the generic name capsules or pods.

One of these capsules comprises an outer cup of impermeable material (e.g., plastic), in which a small cup of permeable or filtering material (e.g., paper) is coaxially received.

This small cup divides the volume of the outer cup into two distinct chambers, of which an upper chamber defined between the mouth of the outer cup and the bottom of the small cup, and a lower chamber defined between the bottom of the small cup and the bottom of the outer cup.

The upper chamber is filled with the food substance, e.g., a dose of ground coffee, and finally closed with a film of impermeable material which is welded onto a flange surrounding the mouth of the outer cup.

In the preparation of the beverage, this impermeable film is perforated to allow hot water to enter the upper chamber containing the foodstuff.

While the food substance is retained by the small cup inside the upper chamber, the beverage, which is formed following the interaction with hot water, can pass through the small cup and collect in the lower chamber, from which it can exit through one or more holes which are made on the bottom of the outer cup.

To manufacture this type of capsule, automatic devices are often used which receive the outer cup, form the small cup, insert it into the outer cup and weld the mouth of the small cup to the mouth of the outer cup.

Traditionally, the weld is achieved with the heat-welding technique, i.e., by means of heated bodies which press the mouth of the small cup against the mouth of the outer cup.

More recently, however, the idea of replacing heat welding with ultrasonic welding has become popular.

In general terms, ultrasonic welding is achieved by applying an intended vibration having an ultrasonic frequency to the pieces to be welded, which produces heat by friction.

This ultrasonic vibration is normally generated by an electromechanical transducer, typically of the piezoelectric type, and is transferred to the parts to be welded through a sonotrode.

For the ultrasonic welding to be effective, however, the contact between the pieces to be welded is necessary and the latter with the sonotrode must be fairly close and precise.

However, ensuring compliance with this condition in the specific case of welding the small cup to the outer cup of the capsule summarised above is a necessity which has not yet been fully met, especially when combined with the simultaneous need to ensure tight lead times and high production rates.

### DISCLOSURE OF THE INVENTION

In light of the above, an object of the present invention is to fulfil the aforementioned need, within the framework of a simple, rational and relatively low-cost solution. These and other objects are reached thanks to the features of the invention as set forth in the independent claims. The dependent claims outline preferred and/or particularly advantageous aspects of the invention which however are not strictly required for the implementation thereof.

In particular, an embodiment of the present invention provides a method for manufacturing packages adapted to contain a food substance for the preparation of beverages, which comprises the steps of:
arranging an outer cup of impermeable material and a die cut of permeable material having larger dimensions with respect to a mouth of the outer cup and resting thereon,
bringing a pusher body in contact with a portion of the die cut facing the cavity of the outer cup,
simultaneously moving the pusher body and an ultrasonic welding sonotrode superimposed thereon towards a bottom wall of the outer cup, so as to axially insert the die cut and at least one portion of the ultrasonic welding sonotrode into the outer cup,
activating the ultrasonic welding sonotrode so as to weld the die cut to the mouth of the outer cup,
extracting the ultrasonic welding sonotrode and the pusher body from the outer cup.

Thanks to this solution, by means of the simultaneous movement of the pusher body and the sonotrode, the die cut is pushed inside the outer cup which, having smaller dimensions, simultaneously causes the die cut to deform and tighten around the sonotrode.

Thereby, at the end of the aforesaid simultaneous movement, not only is a precise insertion of the die cut achieved, but also a secure mutual contact between the die cut, the mouth of the outer cup and the sonotrode.

By means of this simple and rapid procedure, the method according to the invention thus achieves all the conditions for performing an effective ultrasonic welding. According to a first embodiment of the present invention, the die cut can initially be shaped as a flat disc, which has a larger diameter with respect to the diameter of the mouth of the outer cup and is resting transversely thereon.

Thanks to this solution, the simultaneous movement of the pusher body and the sonotrode also has the function of actively shaping the die cut which, from its initial flat shape, assumes the shape of a small cup inserted directly inside the outer cup. Thereby, with a single step it is advantageously possible to both shape the die cut and create the conditions for performing an effective ultrasonic welding thereof to the outer cup.

According to an aspect of this embodiment, the axial insertion step of the die cut and at least one portion of the ultrasonic welding sonotrode in the outer cup can end when a perimeter edge of the die cut is brought inside the outer cup at a level no higher than that of the mouth thereof.

This thereby ensures that, when welding, the small cup defined by the die cut does not protrude from the outer cup.

According to an alternative embodiment, the die cut can initially be shaped (preformed) as a small cup, which has a mouth of larger diameter with respect to the mouth of the outer cup and is axially threaded inside the latter, so that the mouth of the small cup protrudes externally with respect to the mouth of the outer cup. Thanks to this solution, the shaping step of the die cut can be performed separately (in advance), allowing the adoption of dedicated expedients which generally allow the small cup to be given a more precise and/or more complex shape.

According to an aspect of this second embodiment, the step of bringing the pusher body in contact with a portion of the die cut facing the cavity of the outer cup can involve bringing the pusher body inside the small cup in contact with a bottom wall thereof.

Thereby, the contact between the pusher body and the die cut is more extended and stable, ensuring a more precise insertion of the small cup inside the outer body. Another aspect of this embodiment provides that the method can comprise the step of axially inserting at least one portion of the ultrasonic welding sonotrode into the mouth of the small cup, before axially inserting the die cut and at least one portion of the ultrasonic welding sonotrode in the outer cup.

This thereby ensures that, following the subsequent axial insertion by the pusher body, the mouth of the small cup defined by the die cut remains interposed and tight between the mouth of the outer cup and the welding sonotrode.

According to a further aspect of this embodiment, the steps of bringing the pusher body in contact with the bottom wall of the small cup and axially inserting at least one portion of the ultrasonic welding sonotrode in the mouth of the small cup, can occur by means of a simultaneous movement of the pusher body and the ultrasonic welding sonotrode towards the bottom wall of the outer cup.

It is thereby advantageously possible to make even these preliminary positioning steps faster.

Always with a view to making this procedure faster, an aspect of the invention provides that said simultaneous movements of the pusher body and the ultrasonic welding sonotrode towards the bottom wall of the outer cup can occur seamlessly. According to another aspect of this embodiment of the invention, the step of axially inserting the die cut and at least one portion of the ultrasonic welding sonotrode in the outer cup can end when the mouth of the small cup reaches a level no higher than that of the mouth of the outer cup.

This thereby ensures that, when welding, the small cup defined by the die cut does not protrude from the outer cup.

Another embodiment of the present invention provides a device for manufacturing packages adapted to contain a food substance for the preparation of beverages, comprising:
a support element adapted to carry an outer cup of impermeable material and a die cut of permeable material having larger dimensions with respect to a mouth of the outer cup and resting thereon,
an ultrasonic welding sonotrode axially aligned with the outer cup and with the die cut carried by the support element,
a pusher body associated with the ultrasonic welding sonotrode and protruding axially therebelow to go in contact with a portion of the die cut facing the cavity of the outer cup, and at least
a first handling system adapted to axially move the ultrasonic welding sonotrode axially towards and away from the outer cup and the die cut carried by the support element.

This embodiment of the invention essentially achieves the same advantages as the method outlined above, in particular that of allowing an efficient shaping and/or ultrasonic welding of the die cut to the outer cup quickly and safely.

All the ancillary aspects of the invention which have been explained above with reference to the method are also applicable, mutatis mutandis, to the corresponding device.

In addition thereto, an aspect of the invention provides that the sonotrode can comprise at least two portions which are mutually coaxial and axially aligned with the outer cup and with the die cut carried by the support element, of which a cylindrical portion having a diameter substantially equal to the diameter of the mouth of the outer cup and a tapered conical portion derived from an axial end of said cylindrical portion.

The presence of the conical portion also allows the sonotrode to carry out a certain centring function of the die cut inside the outer cup.

According to another aspect of the invention, the pusher body can have a truncated cone shape having a smaller base adapted to contact with the portion of the die cut facing the cavity of the outer cup.

This shape of the pusher body is especially suitable when the die cut is initially shaped as a flat disc, as it cooperates more effectively with the outer cup in deforming it and giving it the shape of a small cup.

Alternatively, the pusher body can have a mushroom-like shape comprising a plate adapted to contact with the portion of the die cut facing the cavity of the outer cup. This shape of the pusher body is especially suitable when the die cut is already initially shaped like a small cup, as it allows to thread such a small cup in the outer cup in a particularly precise and stable manner.

Another aspect of the invention is that the device can comprise a second handling system adapted to allow a mutual axial movement between the ultrasonic welding sonotrode and the pusher body.

Thanks to this solution, it is advantageously possible to adjust the distance between the sonotrode and the pusher body, e.g., according to the sizes of the outer cups, and it is further possible to allow (if necessary) the welding sonotrode to penetrate deeper into the outer cup while keeping the pusher body stationary.

Finally, another aspect of the invention provides that the support element (which carries the outer cup) can be associated with a conveyor adapted to move it through a plurality of operating stations, including at least one loading station of the outer cup onto the support element and one station for releasing the die cut onto the outer cup.

This thereby obtains a device capable not only of performing the welding, but also of arranging the outer cup and the die cut so that the same can be welded.

### BRIEF DESCRIPTION OF THE DRAWINGS

Further features and advantages of the invention will be more apparent after reading the following description provided by way of non-limiting example, with the aid of the accompanying drawings.

FIG. 1 is the section I-I of FIG. 2.

FIG. 2 is a plan view of a container according to an embodiment of the present invention.

FIG. 3 is a schematic view of a device for manufacturing containers like that illustrated in FIG. 1.

FIGS. 4 to 8 show a welding assembly of the device of FIG. 3 in as many steps of its duty cycle.

FIG. 9 is a schematic view of another device for manufacturing containers like that illustrated in FIG. 1.

FIGS. 10 to 11 show a welding assembly of the device of FIG. 9 in as many steps of its duty cycle.

### DETAILED DESCRIPTION

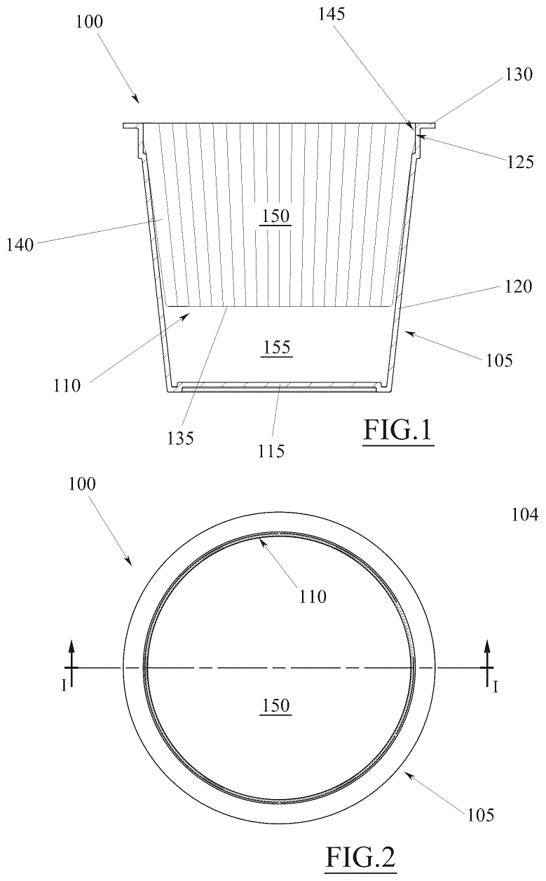

FIGS. 1 and 2 show a package 100 adapted to be filled with a food substance, e.g., a dose of ground coffee, to be then marketed and used in conjunction with a corresponding extraction machine, so as to allow the automatic or semi-automatic preparation of a beverage.

The package 100 essentially comprises an outer cup 105 and a small inner cup 110.

It should promptly be specified that, in the context of the present discussion, the terms ‘cup’ and ‘small cup’ are always used to refer to a container generally having the shape of a cup or a small cup or a tray.

The outer cup 105 can be made of an impermeable material (at least to liquids), e.g., plastic, while the small inner cup 110 can be made of a filtering or permeable material (at least to liquids), e.g., paper.

The outer cup 105 generally comprises a bottom wall 115, preferably flat, and a side wall 120 which, deriving from the bottom wall 115, diverges upwards until it ends at a mouth 125 which can be surrounded by an annular flange 130.

Similarly, the small inner cup 110 also comprises a bottom wall 135, preferably flat, and a side wall 140 which, deriving from the bottom wall 115, diverges upwards until it ends at a mouth 145.

The side wall 140 can be pleated, so as to give the small inner cup 110 the shape of a ramekin.

In the finished package 100, the small inner cup 110 is coaxially received inside the outer cup 105, so that the mouth 145 of the inner cup 110 is substantially at the same level (or however at a level not exceeding) the mouth 125 of the outer cup 105, i.e., at substantially the same distance from the bottom wall 115 of the latter. The mouth 145 of the small inner cup 110, i.e., a (narrow) top band of the side wall 140, is also welded to the mouth 125 of the outer cup 105, i.e., a corresponding (narrow) top band of the side wall 120.

Thereby, the small inner cup 110 subdivides the volume of the outer cup 105 into two distinct chambers, of which a first chamber 150 delimited between the mouth 145 and the bottom wall 135 of the small inner cup 110, and a second chamber 155 defined between the bottom wall 135 of the small inner cup 110 and the bottom wall 115 of the outer cup 105.

The first chamber 150 is adapted to be filled with the dose of food substance, before being closed by an impermeable film (not shown) which can be sealed on the annular flange 130.

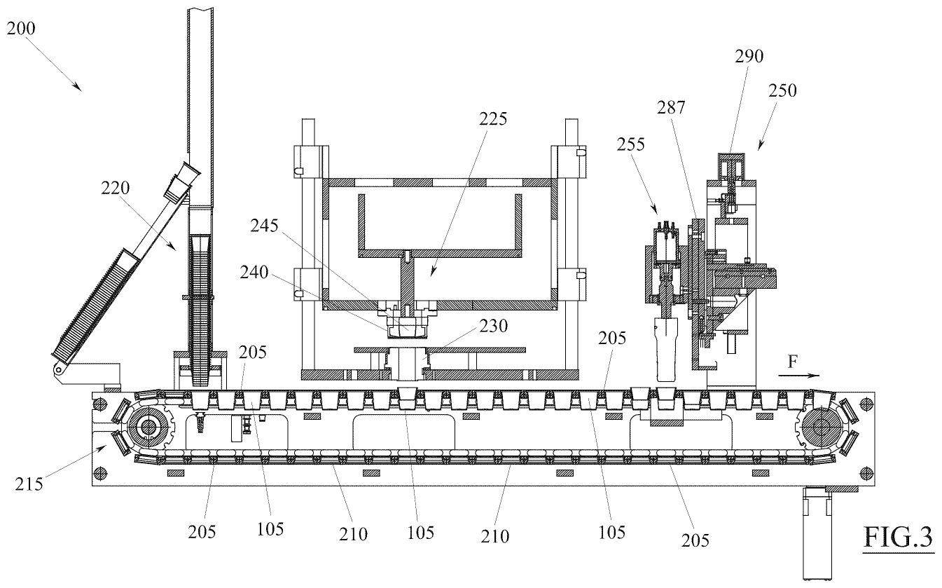

Packages 100 such as that summarised above can be manufactured with the aid of an automated device 200, a first embodiment of which is illustrated in FIG. 3. The device 200 can comprise a plurality of support elements 205, preferably identical to each other, each of which is adapted to carry at least one respective outer cup 105.

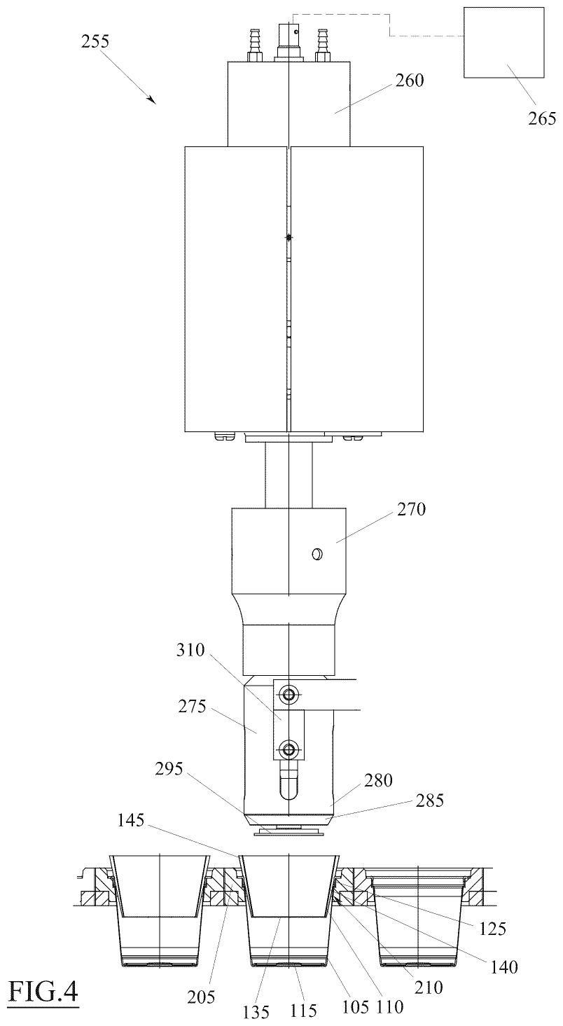

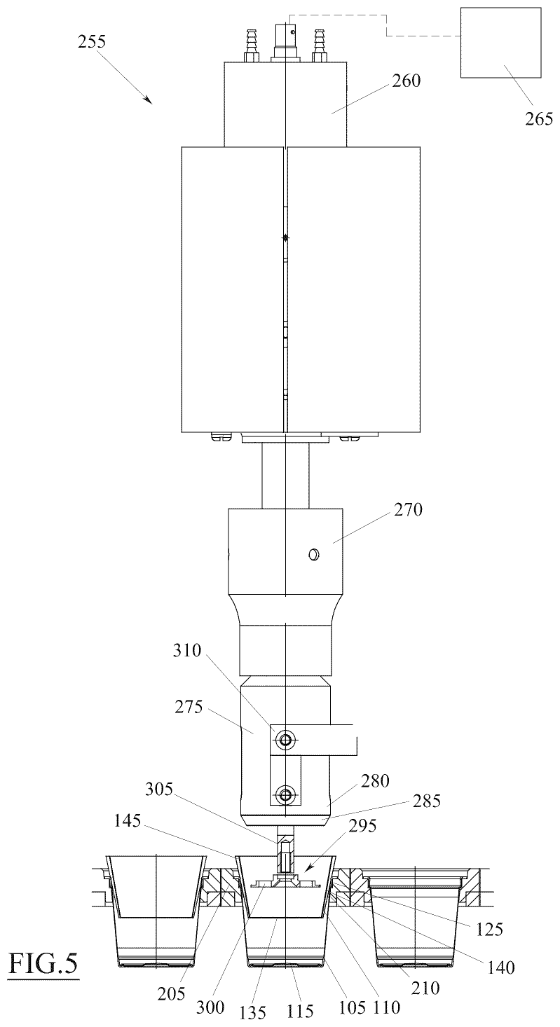

For example, each support element 205 can be formed from a solid body, in the centre of which at least one receiving through hole 210 with a vertical axis is obtained, into which the respective outer cup 105 can be coaxially threaded and supported (see also FIG. 4).

The support element 205 can have a smaller thickness with respect to the height of the outer cup 105, which can therefore protrude below outside the receiving hole 210.

The receiving hole 210 can have an enlarged diameter mouth, which defines an annular shoulder adapted to restingly support the annular flange 130 of the outer cup 105, and a larger lower section, having exactly the same shape and the same dimensions as the side wall 120 of the outer cup 105.

Thereby, at least the top band of the side wall 120, which defines the mouth 125 of the outer cup 105, is in contact with the inner surface of the receiving hole 210, which prevents it from deforming radially outwards.

The support elements 205 can be arranged in succession and associated with a conveyor 215, for example a continuous chain conveyor, which is adapted to advance them along a predetermined feed direction F, stopping them in turn in a plurality of operating stations.

These operating stations can firstly comprise a loading station 220 of the outer cup 105 on the support element 205.

In fact, the outer cups 105 can be manufactured separately, e.g., by means of a dedicated device, which can be placed in line with the device 200 or operated completely independently, so that the outer cups 105 manufactured thereby can be transferred manually or automatically to the loading station 220, which takes care of releasing them in an orderly manner to the support elements 205.

To carry out this function, the loading station 220 can comprise a conventional loader, which is outside the scope of this discussion and will therefore not be described in more detail.

Downstream of the loading station 220 (if present), with respect to the feed direction of the support elements 205, the device 200 can comprise a die-cutting and shaping station 225.

This die-cutting and shaping station 225 is generally configured to both form the small inner cups 110 and to insert each of them inside an outer cup 105 carried by a support element 205.

For example, the die-cutting and shaping station 225 can comprise a forming die 230, located above the support element 205 associated with the conveyor 215, at the centre of which a through cavity is obtained, with a vertical axis, coaxial to the outer cup 105.

Above the forming die 230, the die-cutting and shaping station 225 can comprise an operating unit which includes a thin cylindrical blade 240 and a central punch 245, which is placed in the centre of the cylindrical blade 240 coaxial with the through cavity of the forming die 230.

Both the cylindrical blade 240 and the central punch 245 are associated with appropriate actuating means, e.g., electric or pneumatic actuators, adapted to move them in a vertical direction.

Operationally, a belt of permeable material can be passed between the operating unit and the forming die 230, after which the cylindrical blade 240 is lowered, so as to separate a single portion thereof (also known as a die cut) of essentially discoidal shape.

Immediately thereafter, the centre punch 245 is slid inside the through cavity of the forming die 230, until it protrudes from the lower end of the latter, to partially thread itself inside the outer cup 105 located on the support element 205.

During this downward movement, the centre punch 245 drags the previously cut disc of filtering material therewith, causing it to pass inside the through cavity. Thereby, the central portion of the disc of filtering material, on which the central punch 245 acts directly, remains flat and parallel thereto, while the outer crown is folded upwards, giving the disc (die-cut) the shape of the small inner cup 110.

The inner surface of the through cavity and the outer surface of the centre punch 245 can have corresponding grooves, which are adapted to simultaneously make pleats (if required).

At the end of its stroke, the central punch 245 pushes the small inner cup 110 thus formed out of the through cavity of the forming die 230, releasing it inside the underlying outer cup 105.

Once the insertion is complete, the centre punch 245 and the cylindrical blade 240 return to the initial configuration.

The die-cutting and shaping station 225 is also conventional in itself and, since it is outside the scope of the present discussion, will thus not be described in greater detail.

It should be noted, however, that the die-cutting and shaping station 225 is not configured to push the small inner cup 110 up to the final position inside the outer cup 105.

It is instead configured so that the small inner cup 110, as formed for example at the exit of the forming die 230, has a mouth 145 with a larger diameter with respect to the diameter of the mouth 125 of the outer cup 105, and that the insertion of the same small inner cup 110, determined for example by the stroke of the central punch 245, is only partial inside the outer cup 105 (see for example FIG. 4).

In particular, it is envisaged that the bottom wall 135 of the small inner cup 110 is actually threaded in the outer cup 105 but that its mouth 145, having precisely a larger diameter with respect to the mouth 125 of the outer cup 105, remains axially protruding with respect to the latter by a certain amount.

In other words, given the shape and dimensions of the small inner cup 110, it is envisaged that the same remains resting on the mouth 125 of the outer cup 105 through an intermediate annular band of its side wall 140, the top band of which (i.e., the one defining the mouth 145) protrudes axially outwards.

Downstream of the die-cutting and shaping station 225 (if present), with respect to the feed direction of the support elements 205, the device 200 can comprise a welding station 250 which includes at least one ultrasonic welding assembly 255. Referring in particular to FIGS. 4 to 8, the ultrasonic welding assembly 255 can comprise a series of components fixed in sequence to each other.

These components can comprise in particular a converter 260 (also called transducer or emitter), e.g., of the piezoelectric type, which is electrically connected to an electrical generator 265 (illustrated only schematically).

The electrical generator 265 is an electrical device, e.g., consisting of several electrical circuits, capable of transforming low-frequency electrical energy, e.g., mains energy (at 50 Hz), raising it to higher frequencies, e.g., to ultrasonic frequencies.

The converter 260 is instead a device which transforms the electrical energy supplied by the electrical generator 265 into mechanical vibration energy at essentially the same frequency as the electrical energy received, e.g., through suitable piezoelectric elements.

The ultrasonic welding assembly 255 can also comprise a booster 270, which is rigidly fixed to the converter 260.

The booster 270 is an acoustically calibrated element capable of amplifying, i.e., increasing the amplitude, of the mechanical vibration generated by the converter 260, while leaving the frequency essentially unchanged.

Finally, the ultrasonic welding assembly 255 can comprise a sonotrode 275 rigidly fixed to the converter 260, for example through the booster 270 (if present).

The sonotrode 275 is a component adapted to be brought into contact with the pieces to be welded, so as to transmit the mechanical vibration thereto which causes the welding.

The sonotrode 275 is arranged along the axis of the outer cup 105 which, together with the corresponding small inner cup 110, is carried by the support element 205 into the welding station 250, and is positioned on the side towards which their concavity is facing.

For example, considering the example case in which the outer glass 105 has a vertical axis and concavity facing upwards, the sonotrode is vertically aligned thereabove.

In the exemplary embodiment illustrated in the figures, the sonotrode 275 can comprise a cylindrical portion 280 having an axis coincident with the axis of the outer cup 105.

The diameter of this cylindrical portion 280 is smaller than the diameter of the mouth 145 of the small inner cup 110 which is partially inserted in the outer cup 105, for example substantially equal to or (slightly smaller than) the diameter of the mouth 125 of said outer cup 105.

A conical portion 285 (in this case truncated cone) of the sonotrode 275 can be joined to the axial end of the cylindrical portion 280 facing the inner cup 105 and the small cup 110.

This conical portion 285 is preferably coaxial with the cylindrical portion 280, has a major base which is coincident and having the same diameter as the axial end to which it is joined, and is tapered (narrows) away from the latter, extending towards the inner cup 105 and the small cup 110 which are carried by the support element 205.

For example, the conical portion 285 of the sonotrode 275 can be made in a single body with the cylindrical portion 280.

The opposite end of the cylindrical portion 280 can be rigidly fixed to the converter 260, possibly with the interposition of the booster 270.

As illustrated in FIG. 3, the ultrasonic welding assembly 255 can be associated with guide members 287 adapted to allow them to move in a direction parallel to the axis of the outer cup 105, in this case in a vertical direction, and with motor members 290 adapted to drive such movements.

The motor members 290 can comprise any linear actuator, e.g., electric or pneumatic (e.g., jack).

For each ultrasonic welding assembly 255, the welding station 250 can also comprise a pusher body 295, which can be positioned between the sonotrode 275 and the assembly formed by the outer cup 105 and the small cup 110 which are carried by the support element 205.

This pusher body 295 can have a mushroom-like shape comprising a plate 300 and a rod 305 projecting cantilevered from the centre of the plate 300 with an axis substantially orthogonal to the latter (see for example FIG. 5).

The plate 300, which can be coaxial to the cylindrical portion 280 of the sonotrode 275, can have a diameter substantially equal to or (at least slightly) less than the diameter of the small inner cup 110 which is partially housed in the outer cup 105. The rod 305, which protrudes on the opposite side with respect to the cups 105 and 110, can be coaxially and slidably inserted inside the sonotrode 275, so that it can make relative movements with respect to the latter along the direction of its axis.

These relative movements can be controlled by appropriate motor members (not shown), e.g., hydraulic or pneumatic, which can be connected to the pusher body 295 by means of appropriate leverages 310 and relative hinge pins which insert into corresponding guide slots made in the sonotrode 275.

Operationally, the functioning of the welding station 250 is illustrated with the help of FIGS. 4 to 8.

In an early step illustrated in FIG. 4, the ultrasonic welding assembly 255 can be in a spaced position with respect to the support elements 205 and the pusher body 295 can occupy a set back or retracted with respect to the sonotrode 275.

In this step, the conveyor 215 can advance and subsequently stop a support element 205, coming from the die-cutting and shaping station 225, in such a position whereby the outer cup 105 carried thereby, in which the small inner cup 110 has already been partially inserted, is coaxially aligned with the sonotrode 275.

From this configuration, keeping the ultrasonic welding assembly 255 stationary, the pusher body 295 can be moved axially towards the cups 105 and 110, for example until the distance between the lower surface of the plate 300 and the lower surface of the sonotrode 275 is substantially equal to the height of the small inner cup 110 (see FIG. 5).

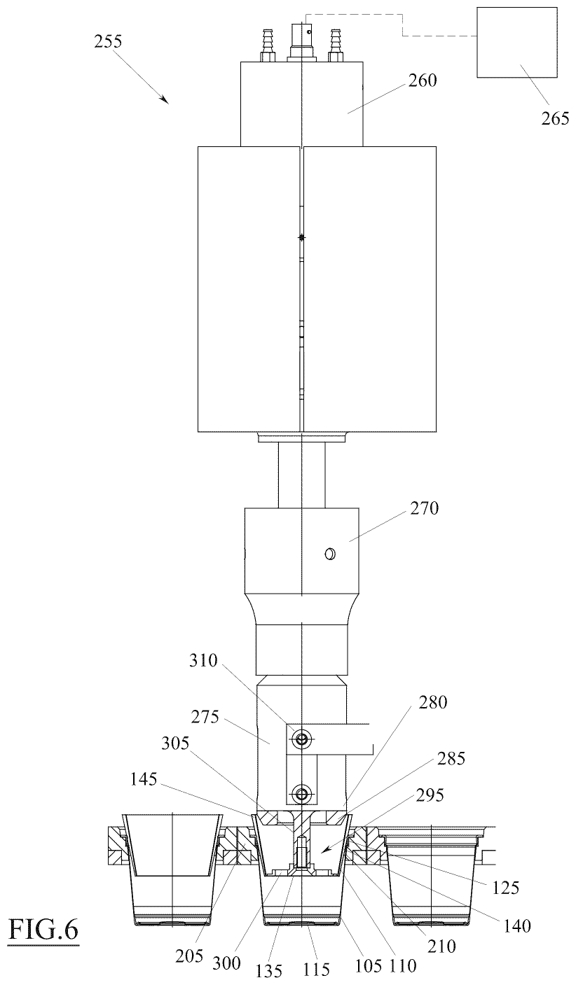

Subsequently, the ultrasonic welding assembly 255 can also be moved towards the cups 105 and 110, so as to axially insert at least one portion of the sonotrode 275 inserted into the mouth 145 of the small inner cup 110 protruding from the mouth 125 of the outer cup 105 (see FIG. 6).

In particular, it is preferable that in this step, inside the mouth 145 of the small inner cup 110, the conical portion 285 is axially inserted, for example in its entirety, possibly leaving the cylindrical portion 280 outside.

At the same time, the pusher body 295, i.e., the lower surface of the plate 300, can be brought into contact against the bottom wall 135 of the small inner cup 110. For example, in this step, the pusher body 295 can be moved simultaneously with the welding assembly 255, thus keeping the mutual distance unchanged.

Thereby, when the pusher body 295 makes contact with the bottom wall 135 of the small inner cup 110, the aforementioned portion of the sonotrode 275, preferably only the conical portion 285, is simultaneously inserted in the mouth 145 of the small inner cup 110.

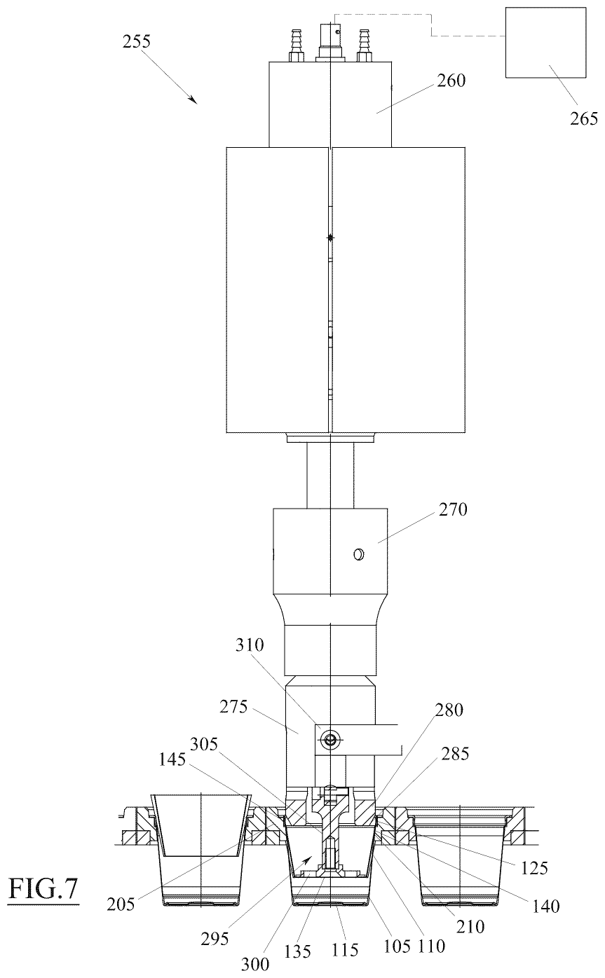

From this configuration, the pusher body 295 and the welding assembly 255 can be simultaneously moved towards the bottom wall of the outer cup 105, thus still keeping their mutual distance (see FIG. 7).

Thereby, the pusher body 295 is effectively capable of pushing the small inner cup 110 deeper inside the outer cup 105, until bringing the mouth 145 of the small inner cup 110 to the same level (or a lower level) as the mouth 125 of the outer cup 105, i.e., to the same distance with respect to the bottom wall 115 of the latter.

At the same time, during this insertion step of the inner cup 110, the mouth 145 thereof, being wider than that of the outer cup 105, sliding on the latter, automatically tends to close towards the centre and to tighten against the portion of the sonotrode 275 surrounded thereby, for example around the conical portion 285. Thereby, at the end of the aforesaid simultaneous movement, not only the correct mutual positioning between the mouth 145 of the small inner cup 110 and between the mouth 125 of the outer cup 105 and the sonotrode 275 is achieved, but also the precise and safe mutual contact.

Of course, the movement steps described with reference to FIGS. 6 and 7 can be carried out seamlessly, i.e., by a continuous simultaneous movement of the pusher body 295 and the welding assembly 255 from the position illustrated in FIG. 6 up to the position illustrated in FIG. 7.

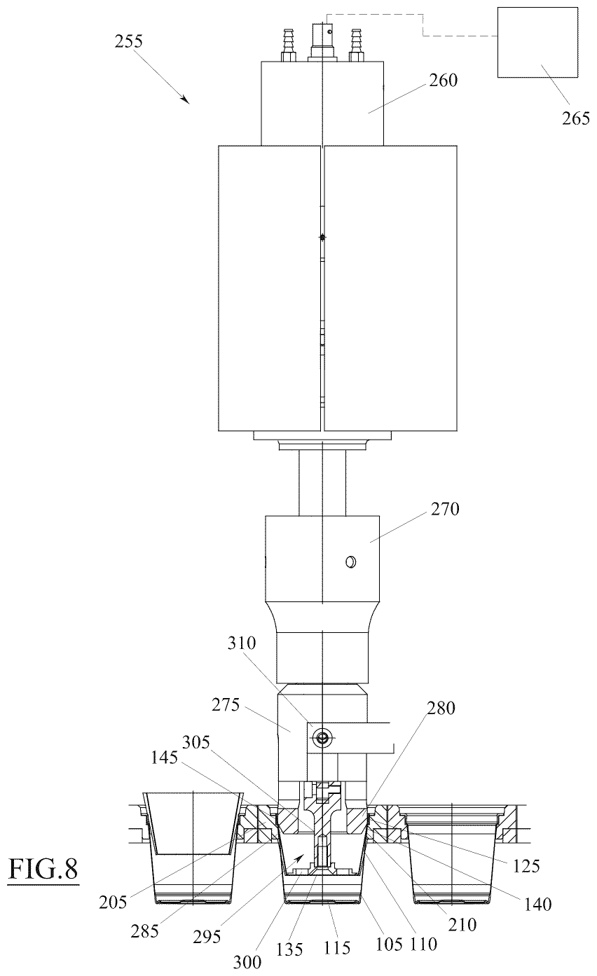

Subsequently, the operation of the welding station 250, can provide for further moving the sonotrode 275 towards the bottom wall 115 of the outer cup 105, while leaving the pusher body 295 stationary, so as to at least partially insert also the cylindrical portion 280 in the mouth 125 of the outer cup 105 and the interposed mouth 145 of the small inner cup 110 (see FIG. 8).

Thereby, it is in fact possible to increase the contact surface and the thrust exerted between the sonotrode 275 and the mouth 145 of the small inner cup 110 and between the latter and the mouth 125 of the outer cup 105.

Once this configuration has been reached, the sonotrode 275 can be activated by operating the converter 260 through the electrical generator 265, so as to weld the mouth 145 of the small inner cup 110 to the mouth 125 of the outer cup 105. Once the welding is complete, it is finally possible to extract the sonotrode 275 and the pusher body 295 from the small inner cup 110 welded to the outer cup 105, obtaining a package 100 and returning to the configuration in FIG. 4, and then repeating the steps described above on a new cup/small cup assembly.

The package 100 obtained can instead be transferred to a machine for filling the first chamber 150 with the food substance and for sealing it with an impermeable film.

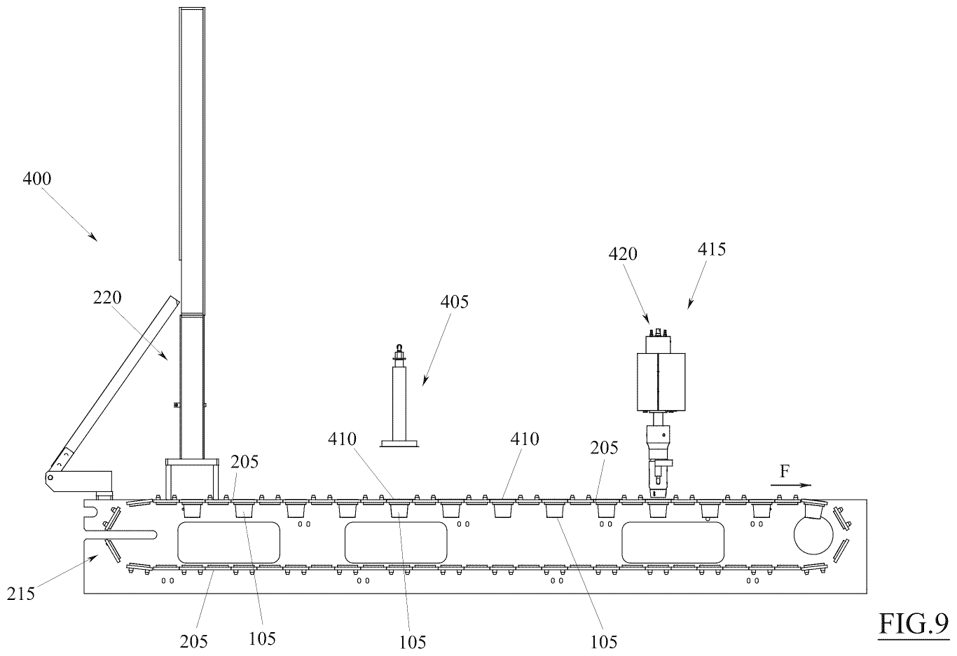

As an alternative to the above, a second embodiment of the invention envisages that packages 100 of the type summarised above can be made with the automated device 400, which is illustrated by way of example in FIG. 9.

This device 400 can also comprise a conveyor 215 adapted to advance a sequence of support elements 205 along a predetermined feed direction F, stopping them in a plurality of operating stations, including a loading station 220 adapted to release the outer cup 105 in the support element 205.

The conveyor 215 with the relative support elements 205 and loading station 220 can be similar to those described for the previous embodiment.

Downstream of the loading station 220 (if present), with respect to the feed direction F of the support elements 205, the device 400 can comprise a die-cutting station 405.

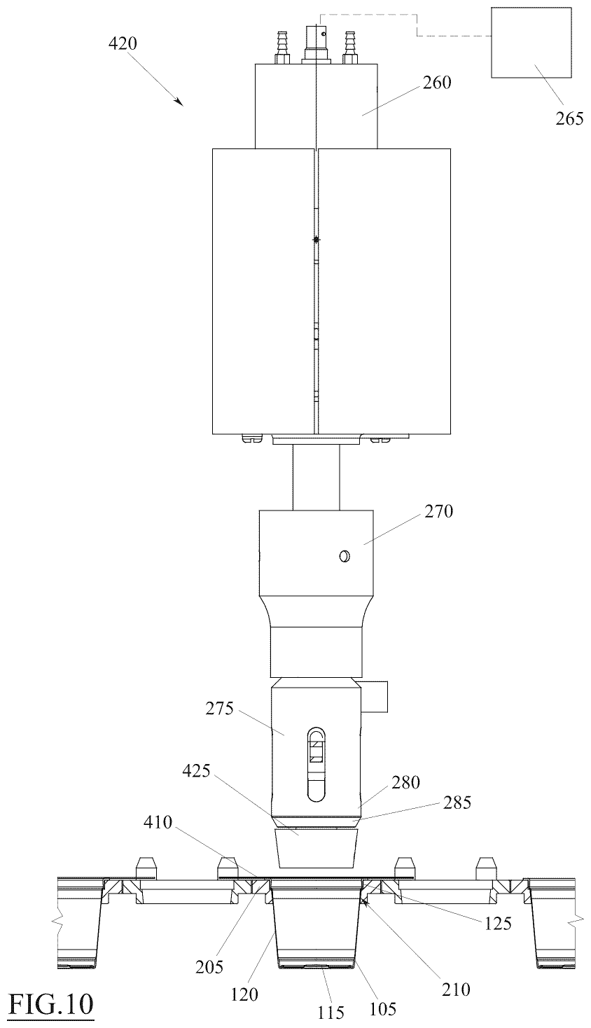

This die cutting station 405 has the task of making individual flat discs 410 of permeable or filtering material (e.g., paper) and releasing them above the mouth 125 of each outer cup 105 which is brought below such a station by the conveyor 215 (see also FIG. 10). In particular, these flat discs 410 can have a larger diameter with respect to the diameter of the mouth 125 of the outer cup 105, and can be rested transversely thereon (i.e., orthogonally to the axis of the outer cup 105), for example so as to completely occlude it.

Preferably, each of these flat discs 410 is positioned centred, i.e., so that its centre is located along said axis of the outer glass 105.

From a constructional point of view, the die-cutting station 405 can be very similar to the die-cutting and shaping station 225 described above, but with the elimination of the forming die 230.

Downstream of the die-cutting station 405 (if present), with respect to the feed direction F of the support elements 205, the device 400 can comprise a welding station 415, which includes at least one ultrasonic welding assembly 420 and guiding members and motors (not illustrated) adapted to move said ultrasonic welding assembly 420 in a direction parallel to the axis of the outer cup 105.

The welding station 415, the relative ultrasonic welding assembly 420, and the relative driving members and motors can be entirely analogous to those described with reference to the first embodiment, with the exception of the pusher body.

In fact, also in this case, each ultrasonic welding assembly 420 can be associated with a pusher body 425, which remains positioned between the sonotrode 275 and the assembly formed by the outer cup 105 and the flat disc 410 resting thereon. This pusher body 425 can, however, have a truncated cone shape, having an axis preferably coincident with the axis of the cylindrical portion 280 of the sonotrode 275, the major base placed near the sonotrode 275 and the minor base placed farther away.

The diameter of the major base of the pusher body 425 can be between the diameter of the major base and the diameter of the minor base of the conical portion 285 of the sonotrode 275, while the diameter of the minor base can be less than the diameter of the minor base of said conical portion 285.

The pusher body 425 can be rigidly fixed to the sonotrode 275, so as to remain fixed thereto.

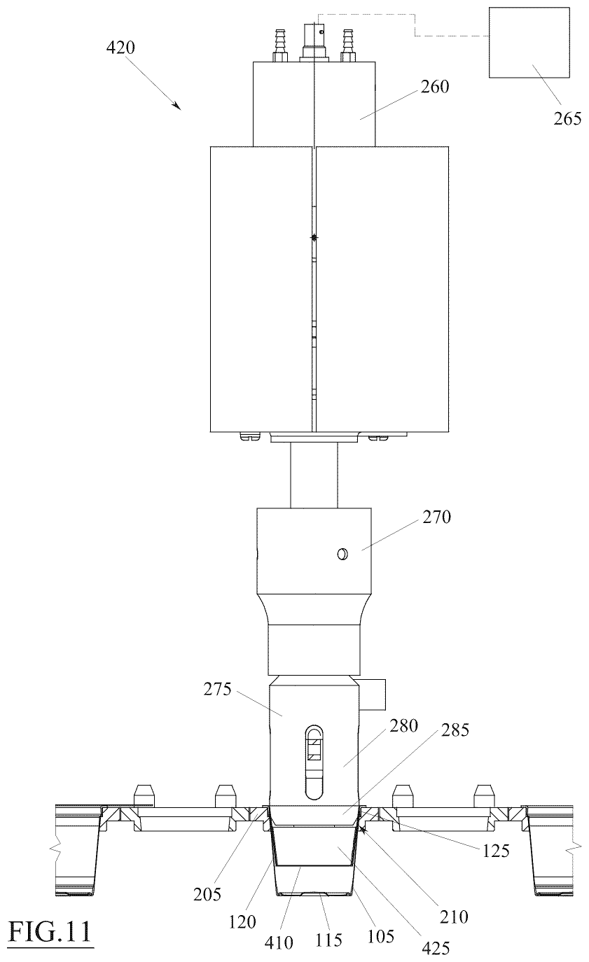

Operationally, the functioning of the welding station 415 is illustrated with the help of FIGS. 10 and 11.

In an initial step illustrated in FIG. 10, the ultrasonic welding assembly 420 can be in a spaced position with respect to the support elements 205 of the conveyor 215. In this step, the conveyor 215 can advance and subsequently stop a support element 205, coming from the die-cutting station 405, in such a position that the outer cup 105 carried thereby, on which a respective flat disc 410 has already been released, is coaxially aligned with the sonotrode 275.

From this configuration, the pusher body 425 and the ultrasonic welding assembly 420 can be moved simultaneously towards the bottom wall of the outer cup 105 (see FIG. 11).

Thereby, the pusher body 425 first comes into contact with a central portion of the flat disc 410 (which faces the inner cavity of the outer cup 105) and, continuing its movement, effectively pushes it inside the outer cup 105.

In doing so, the flat disc 410 is deformed between the pusher body 425 and the side wall 120 of the outer cup 105, assuming the shape of a small cup which also closes and at least partially envelops the sonotrode 275 and is axially inserted in the outer cup 105.

In particular, the diameter of the flat disc 410 is chosen so that, following the aforesaid deformation, its perimeter edge can surround at least the lower portion of the sonotrode 275, for example the conical portion 285 and possibly part of the cylindrical portion 280.

The insertion of the flat disc 410 can then continue until said perimeter edge is contained inside the outer cup 105, at an equal or lesser level with respect to the level of the mouth 125, i.e., at an equal or lesser distance from the bottom wall 115. Thereby, with a single simultaneous movement of the ultrasonic welding assembly 420 and the corresponding pusher body 425, both the shaping of the flat disc 410, which assumes the shape of a small cup, and the correct positioning and mutual contact between the mouth of said small cup, the mouth 125 of the outer cup 105 and the sonotrode 275 are obtained.

At the end of this movement, the sonotrode 275 can be activated by operating the converter 260 through the electrical generator 265, so as to weld the newly formed small to the mouth 125 of the outer cup 105.

Once the welding is complete, it is finally possible to remove the sonotrode 275 and the pusher body 425 from the small cup welded to the outer cup 105, obtaining a package 100 and returning to the configuration in FIG. 10, to then repeat the above steps on a new cup/flat disc assembly.

As in the previous case, the package 100 obtained can instead be transferred to a machine for filling the first chamber 150 with the food substance and for sealing it with an impermeable film.

It should be noted that, with these operating modes, the small cup obtained from the direct deformation of the flat disc 410 will generally not be pleated, but can however have, on its side wall 140, substantially random pleats due to the deformation.

Obviously, an expert in the field can make several technical-applicative modifications without departing from the scope of the invention as hereinbelow claimed.

1. A method for manufacturing packages (100) adapted to contain a food substance for the preparation of beverages, comprising the steps of:
arranging an outer cup (105) of impermeable material and a die cut (110, 410) of permeable material having larger dimensions with respect to a mouth (145) of the outer cup (105) and resting thereon,
bringing a pusher body (295, 425) into contact with a portion of the die cut (110, 410) facing the cavity of the outer cup (105),
simultaneously moving the pusher body (295, 425) and an ultrasonic welding sonotrode (275) superimposed thereon towards a bottom wall (115) of the outer cup (105), so as to axially insert the die cut (110, 410) and at least one portion (285) of the ultrasonic welding sonotrode (275) in the outer cup (105),
activating the ultrasonic welding sonotrode (275) so as to weld the die cut (110, 410) to the mouth (125) of the outer cup (105),
extracting the ultrasonic welding sonotrode (275) and the pusher body (295, 425) from the outer cup (105).

2. A method according to claim 1, wherein the die cut (410) is shaped as a flat disc, which has a larger diameter with respect to the diameter of the mouth (125) of the outer cup (105) and rests transversely thereon.

3. A method according to claim 2, wherein the step of axially inserting the die cut (410) and at least one portion (285) of the ultrasonic welding sonotrode (275) in the outer cup (105) ends when a perimeter edge of the die cut (410) is brought inside the outer cup (105) to a level not exceeding the level of the mouth (125) thereof.

4. A method according to claim 1, wherein the die cut (110) is shaped like a small cup, which has a mouth (145) of a larger diameter with respect to the mouth (125) of the outer cup (105) and is axially threaded inside the latter, so that the mouth (145) of the small cup protrudes externally with respect to the mouth (125) of the outer cup (105).

5. A method according to claim 4, wherein the step of bringing the pusher body (295) into contact with a portion of the die cut (110) facing the cavity of the outer cup (105) comprises bringing the pusher body (295) inside the small in contact with a bottom wall (135) thereof.

6. A method according to claim 5, comprising the step of axially inserting at least one portion (285) of the ultrasonic welding sonotrode (275) in the mouth (145) of the small cup, before axially inserting the die cut (110) and at least one portion (285) of the ultrasonic welding sonotrode (275) in the outer cup (105).

7. A method according to claim 6, wherein the steps of bringing the pusher body (295) in contact with the bottom wall (135) of the small cup and axially inserting at least one portion (285) of the ultrasonic welding sonotrode (275) in the mouth (145) of the small cup are obtained by means of a simultaneous movement of the pusher body (295) and the ultrasonic welding sonotrode (275) towards the bottom wall (115) of the outer cup (105).

8. A method according to claim 7, wherein said simultaneous movements of the pusher body (295) and the ultrasonic welding sonotrode (275) towards the bottom wall (115) of the outer cup (105) occur seamlessly.

9. A method according to any one of claims 4 to 8, wherein the step of axially inserting the die cut (110) and at least one portion (285) of the ultrasonic welding sonotrode (275) in the outer cup (105) ends when the mouth (145) of the small cup reaches a level not exceeding that of the mouth (125) of the outer cup (105).

10. A device (200) for manufacturing packages (100) adapted to contain a food substance for the preparation of beverages, comprising:
a support element (205) adapted to bring an outer cup (105) of impermeable material and a die cut (110, 410) of permeable material having larger dimensions with respect to an opening (145) of the outer cup (105) and resting thereon,
an ultrasonic welding sonotrode (275) axially aligned with the outer cup (105) and the die cut (110, 410) carried by the support element (205),
a pusher body (295, 425) associated with the ultrasonic welding sonotrode (275) and protruding axially therebelow to contact a portion of the die cut (110, 410) facing the cavity of the outer cup (105) carried by the support element (205), and at least
a first handling system (287, 290) adapted to move the ultrasonic welding sonotrode (275) axially towards and away with respect to the outer cup (105) and the die cut (110, 410) carried by the support element (205).

11. A device (200) according to claim 10, wherein the ultrasonic welding sonotrode (275) comprising at least two portions which are mutually coaxial and axially aligned with the outer cup (105) and the die cut (110, 410) carried by the support element (205), including a cylindrical portion (280) having a diameter substantially equal to the diameter of the mouth (125) of the outer cup (105) and a tapered portion (285) derived from an axial end of said cylindrical portion (280).

12. A device (200) according to claim 10 or 11, wherein the pusher body (425) has a truncated cone shape having a minor base adapted to contact with the portion of the die cut (410) facing the cavity of the outer cup (105).

13. A device (200) according to claim 10 or 11, wherein the pusher body (295) has a mushroom-like shape comprising a plate (300) adapted to contact with the portion of the die cut (110) facing the cavity of the outer cup (105).

14. A device (200) according to any one of claims 10 to 13, comprising a second handling system (310) adapted to allow a mutual axial movement between the ultrasonic welding sonotrode (275) and the pusher body (295).

15. A device (200) according to any one of claims 10 to 14, wherein the support element (205) is associated with a conveyor (215) adapted to move it through a plurality of operating stations, including at least one loading station (220) of the outer cup (105) on the support element (205) and a release station (225, 405) of the die cut (110, 410) on the outer cup (105).
